(19) United States
(12) Patent Application Publication
(10) Pub. No.: US 2023/0196145 A1
(43) Pub. Date: Jun. 22, 2023

(54) Order-Sensitive Automated Modeling, Learning and Reasoning in Multivariate Temporal Event Streams to Enable Alerts, Detection, Prediction and Control

(71) Applicant: INTERNATIONAL BUSINESS MACHINES CORPORATION, ARMONK, NY (US)

(72) Inventors: Dharmashankar Subramanian, Yorktown Heights, NY (US); Debarun Bhattacharjya, New York, NY (US); Tian Gao, Berkeley Heights, NJ (US)

(21) Appl. No.: 17/557,015

(22) Filed: Dec. 20, 2021

(51) Int. Cl. G06N 5/04; G06N 5/02

(52) U.S. Cl. CPC G06N 5/043; G06N 5/022

(57) ABSTRACT

A computer implemented method of modeling agent interactions, includes receiving event occurrence data. One or more parent-event types and one or more corresponding child-event types are learned from the event occurrence data. A timeline of the one or more parent-event types and one or more corresponding child-event types is modeled from the event occurrence data. Agent interactions are predicted based on an order of the parent-event types in a predetermined history window.

### BACKGROUND

### Technical Field

The present disclosure generally relates to graphical event models, and more particularly, to methods and systems for using an ordered multivariate temporal event streams to capture an order sensitive historical dependence of events.

### Description of the Related Art

In multivariate event data, the instantaneous rate of an event’s occurrence may be sensitive to the temporal sequence in which other influencing events have occurred in the history. For example, an agent’s actions are typically driven by its own preceding actions as well as those of other relevant agents in some order.

There has been an explosion of datasets in recent years involving events of various types occurring irregularly over the timeline. Many of these involve the actions of single or multiple agents, potentially along with other pertinent observations. Examples include electronic health records and wearable device data, socio-political event data, financial data around trades by automated agents, and user behavior in online retail and entertainment. Such datasets enable statistical approaches for learning about agent actions/interactions.

### SUMMARY

According to various embodiments, a computing device, a non-transitory computer readable storage medium, and a method are provided, with order-sensitive automated modeling, learning and reasoning in multivariate temporal event streams to enable alerts, detection, prediction, and control.

In one embodiment, a computer implemented method of modeling agent interactions can include receiving event occurrence data, where this data can be time-stamped asynchronous, irregularly spaced event occurrence data, for example. The method can include learning one or more parent-event types and one or more corresponding child-event types from the event occurrence data and modeling a timeline of the one or more parent-event types and one or more corresponding child-event types from the event occurrence data. The model can be used to predict agent interactions based on an order of the parent-event types in a predetermined history window.

In some embodiments, a masking function can receive the event occurrence data as input and returns a sub-sequence, where a label is not repeated. In some embodiments, an order instantiation can be determined at a given time over a predetermined history window by applying the masking function to each label from the event occurrence data occurring within the predetermined history window.

According to various embodiments, a computer implemented method includes learning an ordinal graphical event model (OGEM) from an event dataset, including generating an OGEM graph where nodes represent events and edges represent connections between parent nodes to child nodes, and applying conditional intensity parameters to the OGEM graph, wherein the conditional intensity parameters are piece-wise constant overtime, with rate changes occurring whenever there is a change in an order instantiation in a predetermined history window. The method further includes predicting an occurrence of a particular event using summary statistics of counts and durations in the event dataset and the learned conditional intensity rates.

In some embodiments, the event dataset includes event occurrence data as time-stamped asynchronous, irregularly spaced event occurrence data.

In some embodiments, the method further includes applying a masking function that receives the event occurrence data as input and returns a sub-sequence. Typically, the masking function provides a sub-sequence where a label is not repeated. In some embodiments, an order instantiation can be determined at a given time over a predetermined history window by applying the masking function to each label from the event occurrence data occurring within the predetermined history window.

In some embodiments, the predetermined history window is automatically learned from the event occurrence data.

By virtue of the concepts discussed herein, a system and method are provided that improves upon the approaches currently used to predict events from a data stream. The system and methods discussed herein have the technical effect of providing modeling of real-world situations where the dynamics involves different types of events occurring irregularly over time. These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an illustrative event stream with N = 13 events of M = 3 types of events occurring over T = 30 days, where the figure also indicates the order instantiations for each occurrence of event label C, assuming that C has parents A and B and for a window wc = 5, consistent with an illustrative embodiment.

FIG. 2 is an illustrative graphical representation of the event stream of FIG. 1, consistent with an illustrative embodiment.

FIG. 3 is a flow chart illustrating acts involved with determining causality among multiple event types, consistent with an illustrative embodiment.

FIG. 4 is a functional block diagram illustration of a computer hardware platform that can be used to implement an ordinal graphical event model, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system’s registers and/or memories into other data similarly represented as physical quantities within the computing system’s memories, registers or other such information storage, transmission or display devices.

As discussed in greater detail below, the present disclosure generally relates to methods and systems that treat agent actions as event occurrences and deploy machine learning techniques to capture the statistical / causal relationships between various types of events. A model is described that explicitly aims to capture the effect of the order in which preceding events have occurred. Specifically, an event’s arrival rate is assumed to be determined by the recent historical order in which its underlying causal events have occurred. Aspects of the present disclosure fit within the high-level framework of graphical event models, which are continuous-time graphical representations of marked point processes.

Although the model according to aspects of the present disclosure is fairly general and widely applicable, the model, system and methods can be applied to real-world situations pertaining to agent interactions. As an illustration, consider two countries X and Y who have historically been in conflict. In politics, an escalating sequence of actions is often more likely to result in extreme actions such as declaration of war. For instance, if X first makes a negative statement about Y and then Y threatens X, it may be more likely for X to retaliate strongly and declare war on Y than if the reverse order of actions had occurred.

Explicitly recognizing the order of preceding events may also be important for modeling the behavior of individual agents. For instance, the sequence of a big loss followed by a big win may induce different behaviors in a gambler compared to the reverse sequence, or for that matter compared to the situation where they only face either a big loss or a big win. Modeling and learning about the influence of causal orders from event data could provide an analyst with an enhanced understanding of the underlying process.

As discussed in greater detail below, aspects of the present disclosure provide (1) the formulation of an order-dependent event model that explicitly distinguishes the causal impact of different orders in an event dataset. The model can simultaneously take a marked point process view of an event dataset and consider preceding causal event orders; (2) an efficient algorithm for learning the proposed model from an event dataset; (3) an experimental comparison with relevant baselines on event datasets involving both single and multiple agents; and (4) investigative analysis on a political event dataset extract that illustrates the benefits of explicitly identifying order-dependence during the discovery process.

An event dataset (or event stream) is a sequence of time-stamped events of the form D =

$${\left\{\left({l}_{i} , {t}_{i}\right)\right\}}_{i = 1}^{N} ,$$

where tᵢ is the occurrence time of the i^{th} event, tᵢ ∈ ℝ⁺, assumed temporally ordered between start time t₀ = 0 and final time t_{N+1} = T, and lᵢ is an event label/type belonging to an alphabet L with cardinality M = |L|. For simplicity, all equations assume a single event stream but they can be easily extended to multiple independent event streams.

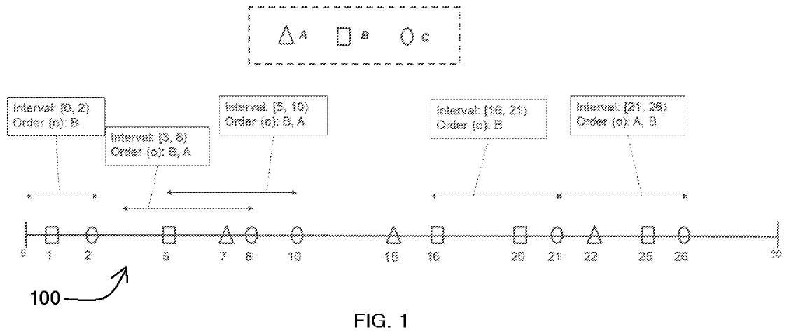

The event dataset in FIG. 1 will be a running example to illustrate aspects of the present disclosure. There are N = 13 events over event label set

$$L = \left\{A , B , C\right\}$$

with cardinality M = 3 over a period of around a month (T = 30 days).

Aspects of the present disclosure describe a model where the historical order of the occurrences of a node’s parent event labels in a graphical event model (GEM) could potentially affect the rate at which it occurs at any time. Since the same event label could occur several times in the history in an event dataset, this could lead to an infinite number of distinct historical possibilities. Therefore, a masking function is provided to disregard specific instances of events that repeat, only retaining distinct event occurrences.

The masking function ϕ(·) takes a sequence of event tuples as input and returns a sub-sequence where a label is not repeated. Formally, ϕ(·) takes as input some temporally ordered sequence s = {(lⱼ, tⱼ)} and returns s′ = {(lₖ, tₖ) ∈ s:lₖ ≠ lₘ for k ≠ m}. The event label order resulting from applying this masking function is obtained from ordering the labels in s′ in time, i.e., {lₖ: (lₖ, tₖ) ∈ s′, tₖ < tₘ∀k < m}.

Here, only two cases of the tuple masking function ϕ(·) are considered due to their simplicity and potential applicability across domains: the ‘first’ and ‘last’ cases, depending on whether only the first or last occurrence of an event label in a sequence is retained to determine order. The use of the first or the last case can depend on the application under consideration.

Consider label C’s occurrence in FIG. 1 at time t = 10. If the ‘first’ masking function is applied to the history at this time, the resulting historical order is B, C, A, whereas ‘last’ results in order B, A, C.

An order instantiation for a set of labels

$$Ζ$$

is a permutation of a subset of

$$Ζ .$$

The order instantiation at time t in an event dataset

$$D$$

over a preceding time window w can be determined by applying masking function ϕ(·) to events restricted to labels

$$Ζ$$

occurring within [max(t –w, 0), t).

Suppose C has parents A and B, such as in FIG. 1, which shows the order instantiations at each of the five occurrences of event label C over its parent labels for a window of 5 days. There are two occurrences of the order A, B, two of order B and one of B, A. In this particular situation, both the ‘first’ and ‘last’ masking function cases result in identical order instantiations.

A model according to aspects of the present disclosure can be formalized where an ordinal graphical event model (OGEM) for event label set

$$L$$

includes the following: (1) a graph

$$G$$

where there is a node for every event label; (2) windows for every node in

$$G , W = \left\{{w}_{X} : X ∈ L\right\} ;$$

and (3) a set of conditional intensity rate parameters 1, one for every node and possible order instantiation with respect to the node’s parents,

$$Λ = \left\{{Λ}_{X} : X ∈ L\right\} = \left\{{λ}_{x \vert o} : X ∈ L \text{,} ∀ \text{o}\right\} .$$

. Here, o denotes an order instantiation, which is a permutation of a subset of X’s parents U – there are

$${\sum }_{i = 0}^{\left|\text{U}\right|} \frac{\left|\text{U}\right| !}{i !}$$

possible orders.

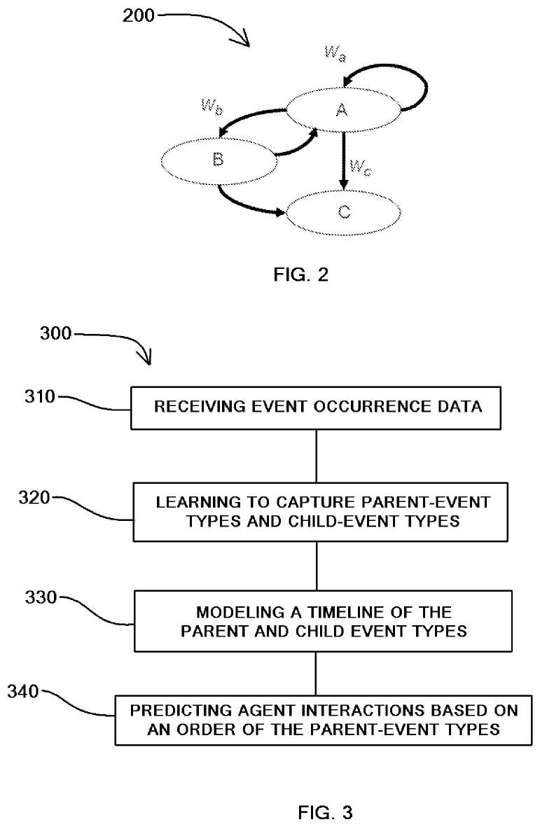

FIG. 2 depicts an example OGEM over

$$L = \left\{A , B , C\right\} .$$

. The graph can be cyclic and even have self-loops indicating self-dependence. The conditional intensity parameters are also shown; for instance, there are 5 parameters for C – one for every order instantiation of its parents {A, B}. Parameter λ_{C|A} is the rate at which event label C occurs given that only A (among its parents) has occurred in the recent preceding window w_{C}, whereas λ_{C|A,B} is the rate when the recent history involves an occurrence of A followed by B. While learning from data, the order is determined by the masking function ϕ(·).

The closest model to an OGEM is the proximal GEM (PGEM), where an event label’s conditional intensity rate depends only on whether or not its parents have occurred in some recent time window. As discussed below, unlike PGEM, OGEM, according to aspects of the present disclosure, can distinguish conditional intensity rates from different parental orders.

Suppose event label X with parents U is generated from order-dependent conditional intensity rates {λ_{x|o}: ∀o}, where o is an order instantiation of U. For two orders o′ and o″ over the same subset of U s.t. λ_{x|o′} ≠ λ_{x|o″}, a PGEM is unable to distinguish between these rates.

Suppose orders o′ and o″ are over variables K ⊆ U variables. While learning from a dataset, both orders map to the binary parental instantiation u of U where variables in K and U\K A are 1 and 0 respectively. Thus, both orders contribute to the estimate for λ̅_{x|u} in the PGEM, which is unable to identify the true parameters λ_{x|o′} and λ_{x|o″}.

An OGEM is intended to explicitly capture the effect of the order of an event label’s causes, unlike conventional order-neutral event models. For instance, orders that are particularly influential in causing an event would have relatively high conditional intensity parameters. Understanding these influences could be beneficial for analysts during the process of discovery.

Aspects of the present disclosure provide an approach for learning an OGEM from an event dataset

$$D \text{.}$$

. The windows

$$W$$

can be treated as hyper-parameters, and the approach can focus on learning the graph

$$G$$

and conditional intensity parameters Λ. The OGEM graph is potentially cyclic, therefore the parents and parameters for each node / event label can be learned individually. The below first shows how to learn conditional intensities {λ_{x|o}: ∀o} for a node X given its parents U (in

$$\left(G\right) ,$$

which relies on computing ordinal summary statistics (Algorithm 1), and then, the below briefly summarize a heuristic graph search method to learn X’s parents U.

An OGEM, according to aspects of the present disclosure, is a particular kind of GEM where the conditional intensity rates are piece-wise constant over time, with rate changes occurring whenever there is a change in the order instantiation in history. The log likelihood of any particular event label X for an event dataset

$$D$$

can therefore be computed using summary statistics of counts and durations in

$$D$$

as well as the model’s conditional intensity rates:

$$log {\text{L}}_{X} \left(D\right) = {\sum }_{\text{o}} \left(- {λ}_{x \vert \text{o}} D \left(\text{o}\right) + N \left(x ; \text{o}\right) ln \left({λ}_{x \vert \text{o}}\right)\right) ,$$

where N(x; o) refers to the number of times X is observed in the dataset and that the order instantiation o is true in the relevant preceding window w_{X}, and D(o) is the duration over the entire time period where the condition o is true. The fact that the counts and durations depend on the window wₓ is hidden in the notation for the sake of simplicity. From equation (1), the maximum likelihood estimates for conditional intensity parameters are

$${\hat{λ}}_{x \vert \text{o}} = \frac{N \left(x ; \text{o}\right)}{D \left(\text{o}\right)} .$$

Thus, if the parents of a node are known, it is straightforward to compute the conditional intensity rates using the summary statistics.

In Algorithm (1) below, it is outlined how to scan the entire dataset to compute the required counts N (x;o) and durations D (o) for an event label X, given its parents U, window wₓ and a masking function ϕ(·). Computing counts is relatively easy if the order instantiation at the current time is known – whenever the label under consideration X is encountered, the relevant count is incremented by one (lines 9-10).

Computing durations is more involved and requires maintaining an active history h. When a parent label is encountered, the corresponding event is appended to h (lines 6-7). Since the order instantiation could potentially change several times between event occurrences, the entire duration between these epochs is appropriately partitioned across order instantiations. These changes are identified by scanning h and determining when a historical event becomes inactive before the next event occurrence (loop in lines 12-20). A sub-routine ‘UpdateOrder’ applies the masking function to the active history and returns an order whenever the active history is modified (lines 8 and 19).

Algorithm 1 : Ordinal Summary Statistics
1: procedure SummaryStats (event label X, parents U, window w_{X}, masking function ϕ(·), dataset D)
2: Active history h ← 0
3: N(x; o) ← 0, D(o) ← 0, ∀o
4: D(Ø)+= t₁ – t₀ ➢ ▷Increment empty set dur.
5: for (lᵢ, tᵢ) ∈ D do ➢ ▷ Scan all events in dataset
6: if lᵢ ∈ U then
7: Append (lᵢ, tᵢ) to h
8: o = UpdateOrder(h,ϕ(·) )
9: if lᵢ = = X then
10: N(x; o)+= 1 ➢ ▷ Increment count
11: Set current time t_{c} = tᵢ
12: for (lᵢ, tᵢ) ∈ h do ➢ Scan events in active history
13: Set inactive time t* = tⱼ + w_{X}
14: if t* = tᵢ₊₁ then
15: Break
16: else ▷ Stay until some history is active
17: D(o)+= t* – t_{c} ▷Increment duration
18: Remove this event (lⱼ, tⱼ) from h
19: o = UpdateOrder(h,ϕ(·) )
20: Set current time t_{c} = t∗
21: D(o)+= tᵢ₊₁ - t_{c} ▷ Increment duration
22: Return counts N(x;o) and durations D(o), ∀o

Algorithm (1) was run on the event dataset in FIG. 1 to obtain counts and durations for event label C, with parents {A, B} and w_{C} = 5 days. The maximum likelihood estimates of intensity rates are:

$${\hat{λ}}_{C \left|∅\right)} = 0$$

,

$${\hat{λ}}_{C \left|A\right)} = 0$$

,

$${\hat{λ}}_{C \left|B\right)} = 0.18$$

,

$${\hat{λ}}_{C \left|A , B\right)} = 0.17$$

,

$${\hat{λ}}_{C \left|B , A\right)} = 0.33$$

. Similar to that described above, here the numbers are identical regardless of whether the ‘first’ or ‘last’ masking function is used. In this particular example, the rate at which C happens almost doubles when B happens before A as compared to the reverse order.

It may be possible for some order instantiations to not be observed in the data, resulting in counts (and therefore estimates for conditional intensities) of zero. This issue can be severe when the number of parents is large, since the number of OGEM parameters increases super-exponentially in the number of parents. As is described below, a parent search approach can restrict model complexity, forcing the learner to choose a small number of parents for a small dataset, making it more likely to have sufficient support in the data. For the proceeding experiments, this issue was dealt with by setting the conditional intensity rate to some small default rate, denoted λ⁰, whenever an order instantiation is not observed in the train set. This is treated as a model hyper-parameter.

A score-and-search approach can be used to find the parents of each node and therefore the underlying graph

$$G$$

. A score is used to incorporate model complexity along with the log likelihood on a dataset. For instance, the Bayesian information criterion (BIC) score for an event label X with parents U is:

$${S}_{X} \left(\text{U} ; D\right) = log {\text{L}}_{X} \left(D\right) - γ \frac{\left|{Λ}_{X}\right|}{2} log \left(T\right) ,$$

where

$$log {\text{L}}_{x} ( D )$$

is the log likelihood for X from equation (2) computed at the maximum likelihood estimates for rates, |Λ_{X}| is the number of free parameters (conditional intensity rates) for X in the model and γ is a penalty weight on the complexity (second) term. Unless otherwise specified, γ is set to 1. The overall score of a graph

$$G$$

is

$$S ( G ) = {{\sum }_{X} S}_{X} ( \text{U} ; D )$$

since the scores are decomposable. For experiments, a forward and backward search procedure can be used to iteratively find the best parental set U for each event label X. Specifically, one candidate event label Z can be iteratively added to U and tested if it results in a better score S_{X}(U ∪ Z) than the current best score. If so, U can be updated and the next Z can be queried. After finishing adding as many nodes as beneficial for the score, the system can iteratively test if removing an event label Z from U would improve the score, updating U if it does indeed result in a better score. Such a greedy procedure is popular for learning probabilistic graphical models in general due to its efficiency and consistency, i.e., ability to recover the true graph with asymptotic data.

A forward backward score-based learning algorithm for OGEM graph

$$G$$

and parameters Λ given hyper-parameters W with summary statistics computed using Algorithm (1) with either the ‘first’ or ‘last’ masking function has worst case time complexity O(M³N), where M and N are the number of event labels and events respectively.

For a single node, Algorithm (1) runs in O(N) time, assuming the ‘UpdateOrder’ subroutine is 0(1); this is possible for both the masking function cases considered. The worst case in the forward (backward) search is that all nodes will be added (removed), which is O(M²). This is repeated for all M nodes to complete the entire graph and model.

Let

$${G}^{′}$$

be the learned graph from a forward backward score-based structure learning algorithm for OGEM graph

$$G$$

. Under the no detailed balance assumption , with sufficient data,

$$P ( {G}^{′} = G ) \to 1 \text{as} T \to ∞$$

.

### EXAMPLE

The efficacy of OGEMs was demonstrated using the following select datasets involving single and multiple agents.

Socio-political events that can be tracked in a political event dataset are an important real-world example of numerous, asynchronous agent interaction events on a timeline. Some such political event databases involves dyadic events where a source actor performs an action on a target actor, for instance ‘Police (Brazil) Assault Protester (Brazil).’ Actors and actions are coded according to the Conflict and Mediation Event Observations (CAMEO) ontology, which was created for interactions among domestic and international actors. For the experiment, 4 out of 5 countries were used from the political event database, which includes events involving 5 types of actors and 5 types of actions, occurring from Jan. 1, 2012 to Dec. 31, 2015. One country was omitted due to the inconsistency between event labels while splitting the data into three sets for experiments.

In one embodiment, a database of patient electronic health records from Intensive Care Unit visits over 7 years is used. Each patient experiences a sequence of visit events, where each event involves a time stamp and diagnosis. Small sequences were filtered out to obtain 650 patients with 204 disease types.

Events for around 70 diabetic patients were considered: these include different types of meal ingestion, exercise and insulin dosage, along with two additional processed event labels corresponding to the increase and decrease of blood glucose measurement levels. These latter events are obtained after discretization of blood glucose measurements into three states.

In one example scenario, an employment networking database was used for employment and (when applicable) college enrollment related information of 2489 anonymous users. Each event stream included a user’s time-stamped records of professional experience, such as joining a new role in a company. The data was filtered to popular companies and ended up with 1000 users.

An experiment to evaluate how well the proposed model fit the afore-mentioned datasets.

Each dataset was split into three sets: train (70%), dev (15%) and test (15%), only retaining event labels that are common to all three splits. Single stream datasets, such as the political event database, were split by time, e.g., if T = 1000 days, then events up to time 700 days are in train. Multiple stream datasets, such as the employment networking database, were split by stream id, e.g., for K = 1000 users, streams for 700 of them constitute the train set. A model’s performance was measured by the log likelihood on the held-out test set. During both training and testing, positive log likelihoods were disallowed to minimize over fitting, capping it at zero for any node. Hyper-parameter choices for OGEM and the baselines are as follows.

A default rate hyper-parameter grid was searched over of λ⁰ = {0.001,0.005,0.01,0.05,0.1}. Window hyper-parameter grids are dataset specific, chosen as, for the political event database: w_{X} = {1,3,7,10,15,30,60} (days) ∀X; Health record database: w_{X} = {0.1,0.2,0.5,1,1.5,2,5} (years) ∀X ; Diabetes: w_{X} = {0.01,0.05,0.1,0.5,1,5} (days) ∀X ; and Employment networking database: w_{X} = {2,5,7,10,15,20} (years) ∀X. The closest baseline is the proximal GEM, which allows different windows for different parents but does not distinguish between orders of causal events. A learning approach was deployed which also identifies windows using a heuristic. A left limiting parameter was used as ∈= 0.001 and default rate λ⁰ as the only hyper-parameter with the same grid as OGEM.

Primarily just for reference, a neural Hawkes process, a state-of-the-art neural architecture for event models, was learned. Neural networks are expected to do much better than fully parametric ones on the model fitting task due to the large number of parameters. NHP does not however learn a graphical model and is less interpretable than the other models considered, making it less useful for discovery. For NHP, the only hyper-parameter is the number of epochs for training.

For all models, the optimal hyper-parameter setting is chosen by training models under various settings using the train set and finding the best performing setting on the dev set. The optimal trained model is then evaluated on the test set.

TABLE 1

Log likelihood for the models on the test sets

| Dataset | PGEM | OGEM | NHP |
|---|---|---|---|
| Political Event | | | |
| Argentina | -1386.05 | -1369 | -1338.65 |
| Brazil | -2000.47 | -2057.45 | -1892.57 |
| Colombia | -534.46 | -517.82 | -559.61 |
| Mexico | -796.50 | -771.17 | -919.82 |
| Health Records | -495.41 | -476.07 | - |
| Diabetes | -2966.23 | -2883.62 | - |
| Employee networking | -1479.26 | -1478.38 | - |

Table (1) compares the log likelihood evaluated on test sets across models. In the OGEM column, the masking function case (‘first’/‘last’) that performs better is shown. Aside from Brazil, where PGEM performs well, OGEM exhibits superior performance. OGEM also does reasonably compared to NHP, beating it on two of the four countries in the political event database; NHP was anticipated to perform substantially better on this task. It should be noted that NHP was not run on the multiple stream datasets because there is a peculiarity about these datasets that makes it an inappropriate baseline- they are processed to almost always have events at time t = 0, and the neural network exploits this by always artificially spiking the conditional intensity rate at the start time. As a result, OGEM was only compared with PGEM for these datasets.

### Example Process

With the foregoing overview of the example OGEM, it may be helpful now to consider a high-level discussion of example processes. To that end, FIG. 3 presents an illustrative process 300 related to the methods for determining causality among multiple event types. Process 300 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 3, the process 300 for determining causality among multiple event types includes an act 310 of receiving, by the computing device, event occurrence data, such as time-stamped asynchronous, irregularly spaced event occurrence data. The process 300 can include an act 320 of learning, by the computing device, from the time-stamped asynchronous, irregularly spaced event occurrence data, to capture one or more parent-event types and one or more corresponding child-event types. The process 300 further includes an act 330 of modeling, by the computing device, a timeline of the one or more parent-event types and one or more corresponding child-event types. The process 300 further includes an act 340 of predicting agent interaction based on an order of the parent-event types in a predetermined history window. Such a model can be used in various aspects of the present disclosure, as discussed in detail above.

### Example Computing Platform

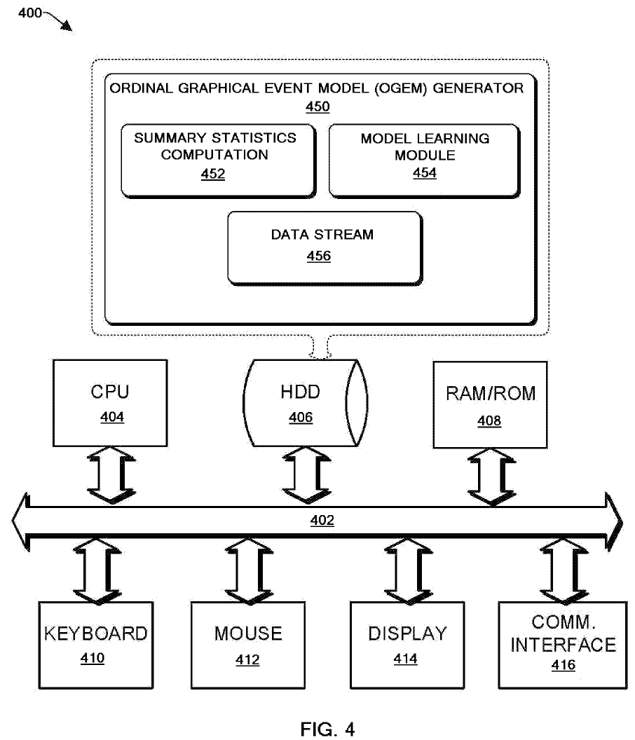

FIG. 4 provides a functional block diagram illustration of a computer hardware platform 400 that can be used to implement a particularly configured computing device that can host a OGEM generator 450. The OGEM generator 450 can include a summary statistics computation module 452, including program code to operate the algorithm (1), described above; a model learning module 454, including learning the graph and the parameters; and a data stream 456, such as the data streams from the example above, as a non-limiting example thereof.

The computer platform 400 may include a central processing unit (CPU) 410, a hard disk drive (HDD) 420, random access memory (RAM) and/or read only memory (ROM) 430, a keyboard 450, a mouse 460, a display 470, and a communication interface 480, which are connected to a system bus 440.

In one embodiment, the HDD 420, has capabilities that include storing a program that can execute various processes, such as the OGEM generator 450, in a manner described herein.

### Conclusion

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method of modeling agent interactions, comprising:
receiving event occurrence data;
learning one or more parent-event types and one or more corresponding child-event types from the event occurrence data;
modeling a timeline of the one or more parent-event types and one or more corresponding child-event types from the event occurrence data; and
predicting agent interaction based on an order of the parent-event types in a predetermined history window.

2. The method of claim 1, wherein the event data is time-stamped asynchronous, irregularly spaced event occurrence data.

3. The method of claim 1, further comprising applying a masking function that receives the event occurrence data as input and returns a sub-sequence where a label is not repeated.

4. The method of claim 3, wherein the masking function is based on either (1) a first masking function, based on a beginning of the history window, or (2) a last masking function, based on a last occurrence of each label in the event occurrence data.

5. The method of claim 3, further comprising determining an order instantiation at a given time over a predetermined history window by applying the masking function to each label from the event occurrence data occurring within the predetermined history window.

6. The method of claim 5, wherein the timeline is modeled as a graph with each node of the graph representative of each label from the event occurrence data.

7. The method of claim 1, wherein the predetermined history window is automatically learned from the event occurrence data.

8. The method of claim 1, further comprising issuing a predictive alert or a feedback signal for an occurrence of an expected event type at an expected time.

9. The method of claim 1, wherein the predictive alert or the feedback signal is issued by tracking a history of occurrences of the expected event type in the event occurrence data in real-time.

10. A computer implemented method comprising:
learning an ordinal graphical event model (OGEM) from an event dataset, including:
generating an OGEM graph where nodes represent events and edges represent connections between parent nodes to child nodes; and
applying conditional intensity parameters to the OGEM graph, wherein the conditional intensity parameters are piece-wise constant over time, with rate changes occurring whenever there is a change in an order instantiation in a predetermined history window; and
predicting an occurrence of a particular event using summary statistics of counts and durations in the event dataset and the conditional intensity parameters.

11. The method of claim 10, wherein the event dataset includes event occurrence data as time-stamped asynchronous, irregularly spaced event occurrence data.

12. The method of claim 11, further comprising applying a masking function that receives the event occurrence data as input and returns a sub-sequence where a label is not repeated.

13. The method of claim 12, further comprising determining an order instantiation at a given time over a predetermined history window by applying the masking function to each label from the event occurrence data occurring within the predetermined history window.

14. The method of claim 13, wherein the predetermined history window is automatically learned from the event occurrence data.

15. A non-transitory computer readable storage medium tangibly embodying a computer readable program code having computer readable instructions that, when executed, causes a computer device to carry out a method of modeling agent interactions, the method comprising:
receiving event occurrence data;
learning one or more parent-event types and one or more corresponding child-event types from the event occurrence data;
modeling a timeline of the one or more parent-event types and one or more corresponding child-event types from the event occurrence data; and
predicting agent interaction based on an order of the parent-event types in a predetermined history window.

16. The method of claim 15, wherein the event data is time-stamped asynchronous, irregularly spaced event occurrence data.

17. The method of claim 15, further comprising applying a masking function that receives the event occurrence data as input and returns a sub-sequence where a label is not repeated.

18. The method of claim 17, wherein the masking function is based on either a first masking function, based on a beginning of the history window, or a last masking function, based on a last occurrence of each label in the event occurrence data.

19. The method of claim 18, further comprising determining an order instantiation at a given time over a predetermined history window by applying the masking function to each label from the event occurrence data occurring within the predetermined history window.

20. The method of claim 15, wherein the predetermined history window is automatically learned from the event occurrence data.
